(19) United States
(12) Patent Application Publication
(10) Pub. No.: US 2017/0290358 A1
(43) Pub. Date: Oct. 12, 2017

(54) SYSTEM AND METHOD FOR AUTOMATED, CONTINUOUS HIGH TEMPERATURE STERILIZATION AND FILLING OF FOOD PRODUCTS

(71) Applicant: John Bean Technologies Corporation, Chicago, IL (US)

(72) Inventors: Zhijun Weng, Fresno, CA (US); Jeffrey A. Dahl, Fresno, CA (US); Douglas Neil Woodruff, Fresno, CA (US); Kevin Andrew Carlson, Kerman, CA (US)

(73) Assignee: John Bean Technologies Corporation, Chicago, IL (US)

(21) Appl. No.: 15/472,150

(22) Filed: Mar. 28, 2017

Related U.S. Application Data
(60) Provisional application No. 62/320,358, filed on Apr. 8, 2016.

(51) Int. Cl. A23L 3/02; A23L 3/00

(52) U.S. Cl. CPC A23L 3/022; A23L 3/003; A23V 2002/00

(57) ABSTRACT

An automated, unmanned continuous system (200) for packaging flowable food products at elevated temperatures and pressures includes an upstream thermal processing station (202) to heat the food products and direct the heated food products to a pressurized unmanned filling station (204), whereat containers (242) are filled with the heated food products within a pressurized housing (232), and then transported to a pressurized and unmanned sealing station (206) where the containers are sealed with a lid or cover (283) within a pressurized housing (282). Thereafter, the filled and sealed containers (242) are routed from the pressurized housing (282) through a pressurized transfer tube or passageway (208) for further processing at a downstream thermal processing station (210).

### CROSS-REFERENCE TO RELATED APPLICATION

This application claims the benefit of U.S. Provisional Patent Application No. 62/320358, filed on Apr. 8, 2016, which is incorporated herein by reference in its entirety.

### BACKGROUND

Existing systems and processes for commercially sterilizing and packaging food products require a significant length of time, which can have detrimental effects on the product quality, including the taste, texture, and color of the sterilized, packaged food product. Current processes of packaging by filling containers with a food or beverage and then sealing or closing the containers require that these functions be carried out at a product temperature below 212° Fahrenheit (“F”), the boiling point of water under normal atmospheric pressure. As a consequence, the overall sterilization and filling/sealing process is protracted since the sterilization process either does not continue during filling and sealing or the process occurs at a slower rate than possible at higher thermal processing temperatures.

Also, in existing commercial sterilizing and packaging (filling/sealing) systems and processer, operators work in a pressurized and elevated temperature environment that is detrimental to health. Operators must decompress in a decompression chamber after working in existing pressurized packaging/filling chambers. This is not a procedure that many employees find agreeable. It would be a benefit it the packaging of food products could be performed without the need for workers to be present in the chambers for filling and sealing containers.

The present disclosure is directed to unmanned continuous systems and methods to package food products or beverages in flexible containers, metal containers, glass jars or other types of containers, with the filling of the containers and the sealing thereof taking place at elevated temperatures and elevated pressures. The present disclosure also relates to the thermal processing of food products prior to being placed into containers and also to the thermal processing of the filled and sealed containers.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A closed, automated, continuous system for processing and packaging flowable food parts into containers at elevated temperatures and pressures includes an unmanned filling station for filling the containers with flowable food products received from an upstream food product supply. The filling station includes:
an automated filling apparatus for directing the flowable food products into containers;
a first housing for closely encasing the filling apparatus, with the housing having access ports to provide access to the interior of the housing;
a pressurizing system for pressurizing the first housing to a pressure above the flash point of the food products; and
a container infeed system for receiving containers into the first housing to be filled.

The system for processing and packaging flowable food parts into containers also includes an unmanned sealing station in container-receiving communication with the filling station. The sealing station includes:
an intake for receiving filled containers from the filling station,
a cover infeed apparatus for receiving covers for the containers,
a closure apparatus to apply the covers to the containers to seal the containers;
a second housing closely encasing the cover infeed apparatus and the closure apparatus; and
a pressurizing system for pressurizing the second housing to a pressure above the flash point of the food product.

The system for processing and packaging flowable food products into containers further includes a sealed transport passageway extending downstream from the sealing station housing for transporting the flow stream of filled and sealed containers for further processing.

The system of the present disclosure also includes a weighing system for weighing the filled and sealed containers.

The system according to the present disclosure further includes a temperature measurement station for measuring the temperature of the contents of the filled and sealed containers.

The system according to the present disclosure further including a source of HVAC for maintaining the interior of the filling station housing at a desired temperature and moisture level as well as for maintaining the sealing station housing at the desired temperature and moisture level. The HVAC source may be provided to other sections or components of the system.

The system according to the present disclosure further including a source of pressurized air to maintain the pressure within the filling station housing, sealing station housing, and other sections of the system at desired pressure levels.

The system of the present disclosure further including an upstream thermal processing station in food product flow communication with the filling station. The upstream thermal processing station thermally processing the flowable food product to a temperature in a temperature range of about 212° F. to 290° F. and more specifically about 260° F.-280° F.

The system of the present disclosure further including a washing station located downstream from the sealing station for washing the filled and sealed containers. The washing station includes a washing apparatus to apply washing fluid to the exterior of the filled and sealed containers as well as a housing sealed from the ambient and closely encasing the washing apparatus.

The system of the present disclosure further including a quality control station downstream of the sealing station. The quality control station comprising a temperature measurement apparatus for measuring the temperature of the contents of the closed and sealed containers. The temperature measuring can be conducted on a statistical basis rather than measuring the temperature of each container.

The system of the present disclosure further comprising a container diversion system for diverting selected containers from the flow stream of filled containers and directing such selected containers to the quality control station.

The system of the present disclosure further including a downstream thermal processing station for receiving filled and sealed containers from the sealed transport passageway, and then thermal processing such filled and sealed containers to achieve a desired sterilization/pasteurization level of the food products within the filled and sealed containers.

A method for automatically and continuously filling and sealing food product containers traveling in a flow stream at an elevated temperature and pressure includes filling containers with thermally processed flowable food products at an unmanned filling station with an automated filling apparatus for directing the flowable food products into containers. The automated filling apparatus portion of the filling station is encased within a close-fitting first housing, with the pressure within the first housing maintained at a level above the flash point of the food products being filled into the containers. The method also includes sealing the containers at a sealing station downstream from the filling station, wherein the sealing apparatus portion of the sealing station encased within a close-fitting second housing capable of maintaining the pressure within the second housing at a pressure above the flash point of the food products in the containers. The method also includes transporting the filled and sealed containers through a sealed transport passageway at an elevated temperature of at least 100° F. to 220° F. from the sealing station to a downstream location for further processing.

The method of the present disclosure further includes weighing the filled and sealed containers and noting if any of the containers are of undesirable weight. Such undesirable weight containers can be diverted so as to not undergo further processing.

The method of the present disclosure further includes measuring the temperature of the contents of the filled and sealed containers and noting any containers wherein the contents are below a selected setpoint temperature.

The method of the present disclosure further includes providing HVAC to the first and second housings to control the temperature and moisture levels within the first and second housings at selected setpoints. HVAC can be provided to other locations of the travel path of the containers.

The method of the present disclosure further including washing the exterior of the filled and sealed cans prior to further processing of the filled and sealed cans.

The method of the present disclosure, further comprising diverting selected containers from the flow stream of filled and sealed containers to assess the quality of the food products within the containers and/or the quality of the sealing of the containers.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows in schematic view a system and method for the automated and continuous packaging of food products at elevated temperatures and pressures and the thermal processing of the packaged food products;

FIG. 2 is a flow diagram of a first system and method corresponding to FIG. 1;

FIG. 3 is a second flow diagram of a system and method corresponding to FIG. 1;

FIGS. 4A and 4B show a schematic view of a further embodiment of the system and method for automated and continuous packaging of food products at elevated temperatures and pressures and the thermal processing of the packaged food products;

FIG. 5 is a fragmentary enlarged schematic view of a portion of FIG. 4B;

FIG. 6 is an enlarged fragmentary view of a portion of FIG. 4B taken substantially from the opposite side of FIG. 4B from FIG. 6;

FIG. 7 is an enlarged fragmentary view of a portion of FIG. 4B;

FIG. 8 is an enlarged fragmentary view of a portion of FIG. 4B taken from the opposite side of FIG. 7;

FIG. 9 is an enlarged fragmentary view of a portion of FIG. 4B;

FIG. 10 is an enlarged fragmentary view of a portion of FIG. 4B; and

FIGS. 11A and 11B depict a flow diagram of a system and method corresponding to FIGS. 4A and 4B.

### DESCRIPTION OF THE INVENTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “upward,” “downward,” “right hand,” “left hand,” “in,” “out,” “extended,” “advanced,” “retracted,” “proximal,” and “distal.” These references and other similar references in the present application are only to assist in helping describe and understand the present invention and are not intended to limit the present invention to these directions.

The present application may include modifiers such as the words “generally,” “approximately,” “about”, or “substantially.” These terms are meant to serve as modifiers to indicate that the “dimension,” “shape,” “temperature,” or other physical parameter, in question need not be exact, but may vary as long as the function that is required to be performed can be carried out. For example, in the phrase “generally circular in shape,” the shape need not be exactly circular as long as the required function of the structure in question can be carried out.

In the present application the term “packaging” includes canning and bottling. Moreover, canning includes filling metal, glass or other containers and then sealing the container with a lid, cover, top or cap.

In the following description, various embodiments of the present disclosure are described. In the following description and in the accompanying drawings, the corresponding systems assemblies, apparatus and units may be identified by the same part number, but with an alpha suffix. The descriptions of the parts/components of such systems assemblies, apparatus, and units are the same or similar are not repeated so as to avoid redundancy in the present application.

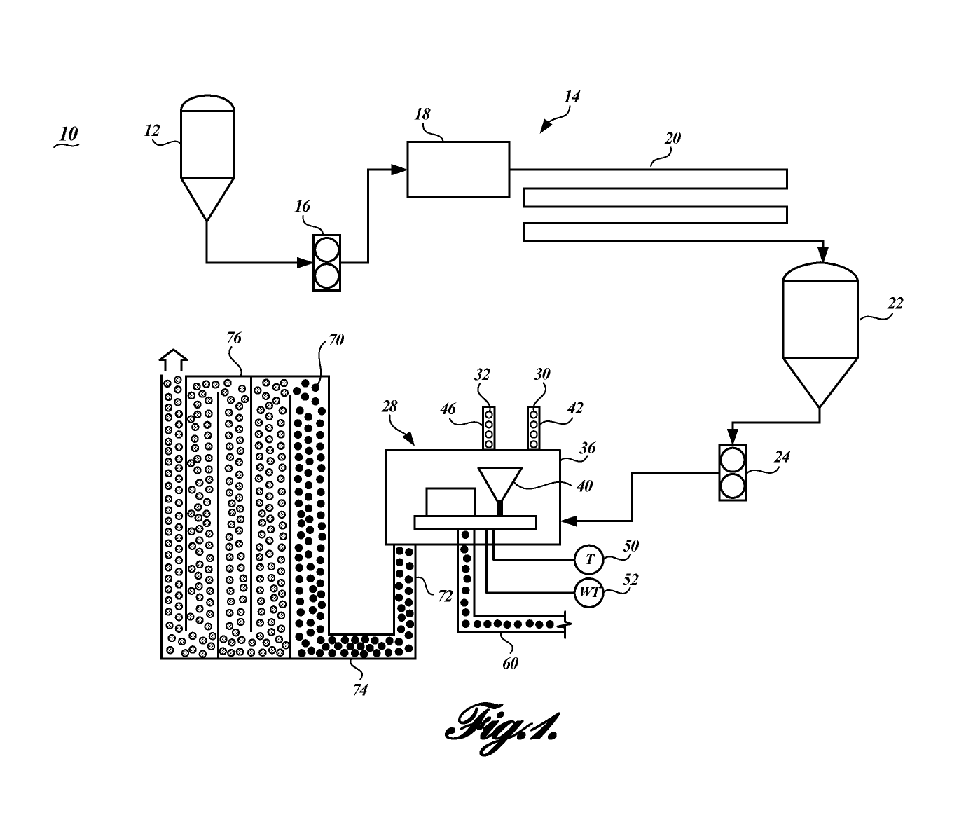

Referring to FIG. 1, the present disclosure pertains to an automated continuous system and method for thermally processing food products and packaging food products at elevated temperatures and pressures. The system 10 includes a formulated product feed tank 12 for storing the food product to be sterilized and packaged. Although only one feed tank 12 is shown, the system 10 may utilize several feed tanks, employing the same or different food products. In the case of different food products, the food products from the storage tanks may be blended or mixed in a mixing apparatus in a well-known manner to produce a pumpable formulated product or beverage that is routed to a first thermal processing station 14 by a pump 16.

At the first thermal processing station 14, the formulated food product is rapidly heated to a product temperature of about 212° F. to 290° F. and more specifically about 260° F. to 280° F. through the use of a heating unit 18. Various types of heating units may be used to rapidly heat the formulated food product, including, for example, a culinary steam direct injection system, a microwave or radio frequency heating unit, or an electrically powered ohmic heating unit. Other types of heating units may also be employed. Although one heating unit 18 is illustrated, a number of connected heating units may be used, thereby to rapidly increase the temperature of the food product.

Once heated by heating unit 18, the food product next passes through a tubular holding unit or heat exchanger 20. Various types of tubular heat exchangers can be employed. By the time the food product leaves the heat exchanger 20, the temperature of the food product may be such that commercial sterility has been achieved. This means that the level of pathogens within the heat product has been lowered to a level specified in food processing regulations. However, it is not necessary that commercial sterility in fact has been accomplished by the time the food products leave the heat exchanger 20. Further, thermal processing of the food product can occur beyond the heat exchanger 20.

From the heat exchanger 20, the food product enters a hot “hold” tank 22. The food product within the hold tank 22 is maintained in a temperature range of about 212° F. to 290° F. and more specifically of about 240° F. to about 250° F. To this end, the hold tank may be jacketed with a heating unit, for example, a steam heating unit.

From the hold tank 22, the food product is pumped by pump 24 to an automated filling and sealing station 28, wherein containers 30 are filled with the food product, and then the containers are sealed, for example, using covers 32. Of course some types of containers may instead use screw-on lids or caps. The filling and sealing of the containers 30 occurs within a pressure vessel 36 which is maintained at an elevated temperature of about 212° F. to 290° F. and more specifically from about 240° F. to about 250° F. and at an elevated pressure of about 10 psig to 15 psig to remain above the flash point of the product to prevent boiling of the product. As a non-limiting example, the elevated pressure within the pressure vessel 36 may be about 15 psig assuming this is above the flash point of the product.

Because of the elevated pressure and temperature within the pressure vessel 36, the filling and sealing of the containers 30 within the pressure vessel must be carried out automatically, without the presence of human personnel, as has been required to-date. To this end, commercially available filling and sealing apparatus 40 are commercially available and are sufficiently robust to operate within the elevated temperature and pressure within the pressure vessel 36.

Empty containers 30 are routed to the pressure vessel 36 and then to the filling and sealing apparatus 40 through an inlet stream 42. A valve, not shown, is employed at the interface with the pressure vessel 36 for introducing the empty containers 30 into the pressure vessel while minimizing the escape of heat and/or pressure from the pressure vessel. Correspondingly, if utilized, closures or covers 32 for the containers 30 are routed to the pressure vessel 36 through an inlet stream 46. A valve, not shown, is positioned at the interface between the inlet stream 46 and the pressure vessel 36 for introducing the closures 32 into the pressure vessel while minimizing the escape of heat and/or pressure from the pressure vessel.

While in the pressure vessel, the temperature of the food product within the filled containers 30 may be measured utilizing a temperature measuring apparatus 50 to determine if a temperature threshold has been met. Likewise, the weight of the filled containers 30 may be measured using a weight measuring apparatus 52 to verify whether or not the container 30 has been filled with a minimum product quantity. If either of the desired temperature level of the food product within the container 30 has not been met and/or the desired weight of the food product within the container has not been met, then the affected containers are diverted into a diversion stream 60. The diverted food product may be directed to a food product rework area for further thermal processing. As an alternative, the diverted food product may be removed from the containers 30 and rerouted to other locations within the system 10, for example, to feed tank 12, for subsequent thermal processing by the thermal processing station 14. Temperature is measured from a sample, for example, one to three containers every 15 minutes. This is a destructive test (to the container), so the food product is either scrapped or cycled back to the hold tank 22. Weight measurements can be made “on the fly” in a non-destructive manner. Deviations would be either scrapped or opened and the food product returned to hold tank 22.

The temperature and weight of all containers of the food products need not be measured. Rather, a statistical sampling methodology may be employed to measure the temperature and weight of the filled containers while maintaining a desired confidence level of the temperature and weight measurements being taken.

Rejected containers 30 may also be routed to the diversion stream 60. The rejection of the containers may be due to various reasons including, for example, an improper or inadequate seal between the container 30 and its cover 32.

Referring back to fill station 28, the filled containers 30 are closed or sealed within the pressure vessel 36 and then routed to a second thermal processing station 70, where further thermal processing of the food product and its container 30 occurs, as discussed more fully below. As noted above, the filling and sealing process at station 28 occurs at an elevated temperature of about 212° F. to about 290° F. and more specifically from about 240° F. to about 250° F. so as to prevent cool-down of the food product during the filling and sealing stages. Also, to prevent product boiling, it is necessary to maintain the pressure within the vessel 36 at an elevated level. For example, for a product filling temperature of 250° F., the pressure within the vessel 36 must be controlled to at least about 15 psig. This can be accomplished by introducing pressurized air or steam into the pressure vessel 36. Moreover, a circulation fan may be utilized within the pressure vessel to maintain a uniform temperature distribution within the vessel.

Periodically the seam between the cover and container is inspected. The frequency of the inspections is in compliance with regulatory agencies requirements for inspection of the seamed cover/lid This is termed the “seam tear down test.” One sample from every seaming head in the closure is checked. This is a destructive test where the seam is cut at one or more locations to determine the quality of the seam.

Pressure vessels, such as vessel 36, are articles of commerce. They can include various features, for example, quick-opening doors at one or both ends of the vessel in case rapid access into the interior of the vessel is required. Also, the floor of the vessel can be grated to facilitate wash-down of the equipment within the vessel. Also, a valved draining system may be employed if the vessel needs to be drained while it is pressurized during use. Cameras can be mounted inside the vessel to monitor the filling and sealing operations therein. Moreover, pressure release safety valves may be employed to relieve the pressure within the vessel, if the pressure exceeds a certain level or to depressurize the vessel so as to gain access to the interior of the vessel.

An HVAC system can be employed to supply dehumidified air to the pressure vessel. One goal is to elevate the ambient temperature of the interior components of the vessel above the dewpoint so that moisture in the air within the vessel will not condense on the equipment and drip into the food product inside the vessel. It is noted that the robotic systems for the filling and sealing functions within the vessel typically require a working environment with a relative humidity of less than about 75%. The HVAC system is utilized to control the relative humidity within the vessel to below this level.

Although in FIG. 1 a singular pressure vessel 36 is illustrated, two or more pressure vessels may be utilized in tandem to meet required production levels. To accommodate different food product ingredients, which may have different heat sensitivities, multiple fillers may be employed within the one or more pressure vessels 36.

FIG. 1 schematically illustrates that the second thermal processing station 70 is in the form of a hydrostatic system, which is capable of continuously sterilizing the sealed containers 30. Such hydrostatic systems are well known in the art. A valve, not shown, may be required between the pressure vessel 36 and the inlet 72 to the second thermal processing station 70 to prevent water from entering the vessel 36, and also to prevent pressure loss within the vessel 36. A water level probe may be utilized within the vessel 36 to operate the valve. The filled containers may be transported through the passageway 74 using a belt conveyance system, a pocket conveyance system, or other type of commercially available conveyance system.

In the second thermal processing station 70, the coldest spot within the product container reaches a high enough temperature (about 240° F. to 250° F.) to achieve a sufficiently high lethality of bacteria/micro-organisms that may be in the food product. As such, commercial sterility is achieved within the second thermal processing station 70, if it had not been reached previously.

From the second thermal processing station 70, the containers 30 pass through a third thermal processing station 76 to cool the food product. The third thermal processing station 76 is schematically illustrated as also of a hydrostatic design. Sufficient water column height and air overpressure is employed to control the expansion and contraction of the food product within the thermal processing stations 70 and 76. Once the food product containers have passed through the third thermal processing station 76, they are lowered to a temperature below that required for sterilization/pasteurization of the food product. Typically the temperature of the food product and containers exiting the third thermal processing station will be in the range of about 125° F. to 175° F.

Although the thermal processing stations 70 and 76 are schematically illustrated as consisting of a hydrostatic system, other types of thermal processing systems may be utilized. Examples include a rotary sterilizer or a continuous belt sterilizer. Both of these alternative sterilizers are articles of commerce.

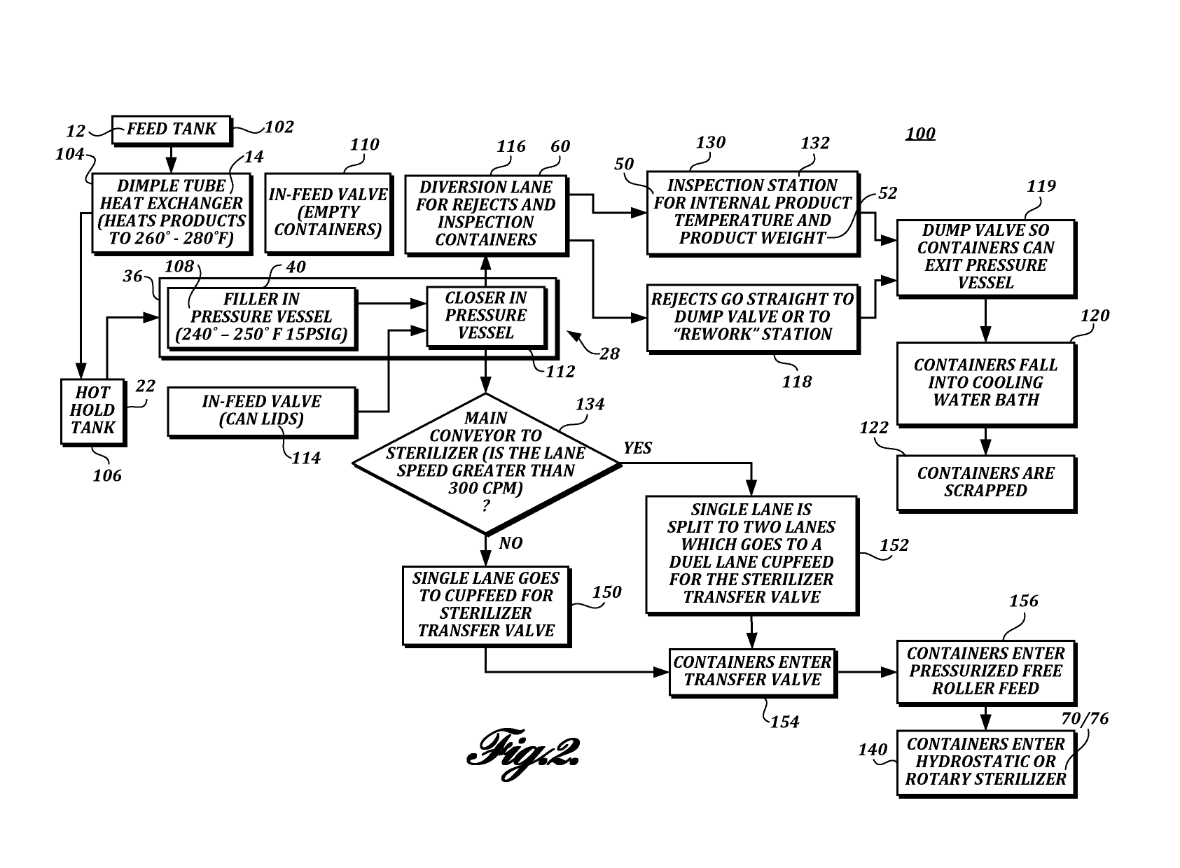

Referring to FIG. 2, an embodiment of a method and system 100 for automatically and continuously thermal processing food products and packaging the food products at elevated temperatures and pressures is disclosed. In step 102, the formulated food product is stored in feed tank 12. In step 104, the formulated food product is heated at thermal processing station 14, which includes a dimpled, tube-type heat exchanger, wherein the food product is heated to approximately 212° F. to 290° F. and more specifically to approximately 260° F. to 280° F. In step 106, the food product from the thermal processing station is routed to and held in a heated hold tank 22. Thereafter, the formulated food product is transmitted to filling apparatus 40, located within pressure vessel 36, where empty containers 30 are filled with the food product in step 108. The empty containers 30 are fed to the filler apparatus 40 in step 110. Filling of the containers 30 occurs at a temperature in the range of about 212° F. to 290° F. and more specifically of about 240° F. to 250° F. and at a pressure of about 15 psig. Thereafter, the filled containers are closed in step 112 employing the apparatus 40 located in the pressure vessel, using, for example, can lids 32 that are fed to the closer in step 114.

Next, in step 116, rejected containers 30 as well as containers for inspection are routed through a diversion lane 60. The containers may be rejected because of not being sealed properly or for other reasons. For example, for containers in the form of cans, the can seamer can be fitted with a seam monitoring device, and this device triggers a rejection when it detects a problem seam.

In step 118, the rejected containers may be forwarded to a dump valve or to a product rework station. The dump valve is a valve that carries the container 30 out of the vessel 36. The rejected container is opened and the food product is returned to the fill tank 22 and the container is exited through the dump valve at step 119 to be scrapped. In this regard, the emptied containers exit the pressure vessel 36 at step 120 and are placed in a cooling water bath. Next, in step 122, the containers are scrapped.

Those containers 30 in the filling lane that are scheduled for inspection are transmitted to an inspection station 130 located within the pressure vessel. Inspection occurs at step 132 with respect to the temperature of the food product and/or container, as well as the weight of the combined container and food product. For those containers that pass inspection, the containers may be routed back to the main conveyor 134, which transports the filled containers from the pressure vessel 36 to a rotary sterilizer 140, as shown in FIG. 2. At the inspection station 130, approximately one to three cans are tested every 15 minutes.

From the inspection station 130, the contents of the containers that do not pass inspection may be routed to the dump valve 118, discussed above.

The filled containers from pressure vessel 36 are routed to a hydrostatic sterilizer 140 through a single routing lane 150 or a dual routing lane 152, depending on the number of containers processed per minute. Typically the cross-over point requiring dual routing lanes is about 300 containers per minute. Regardless of whether a single or dual routing lanes are used, the containers enter a transfer valve 154, then enter a pressurized free roller feed 156 to feed the containers into the rotary sterilizer 140, wherein the food products within the containers 30 are thermally processed to a desired lethality level, and are thereafter cooled to a temperature level below that required for sterilization or pasteurization.

It will be appreciated that, by the foregoing process, the thermal processing (sterilization and/or pasteurization) may occur at a significantly shorter time period than in existing thermal processing and filling methodology, at least in part due to the elevated temperature and pressure at which the food product is packaged into containers and sealed therein. As noted above, the filling of the containers occurs in a pressure vessel wherein the temperature within the vessel may be in the range of about 212° F. to 290° F. and more specifically of about 240° F. to 250° F. and at a pressure of approximately 15 psig. The time periods from initially heating the food product at thermal processing station 14 to the time period required for the filled containers to reach the second thermal processing station can vary wide, depending on various factors, including the nature of the food product, including its pH level, its viscosity, and whether the food product contains solid particles and not just a liquid. The total time period for thermal processing the food product and filling containers with the food product, as well as sealing the containers, can vary from a total of about three minutes to up to about 25 minutes. The present system and method is especially advantageous for viscous liquids that are packaged in relatively large-size metal cans. Such food products may include, for example, gravies, tomato sauce, pumpkin, meat, cheese, chili, etc. Using current methodology, the same thermal heating of these food products and the packaging thereof can require significantly more time.

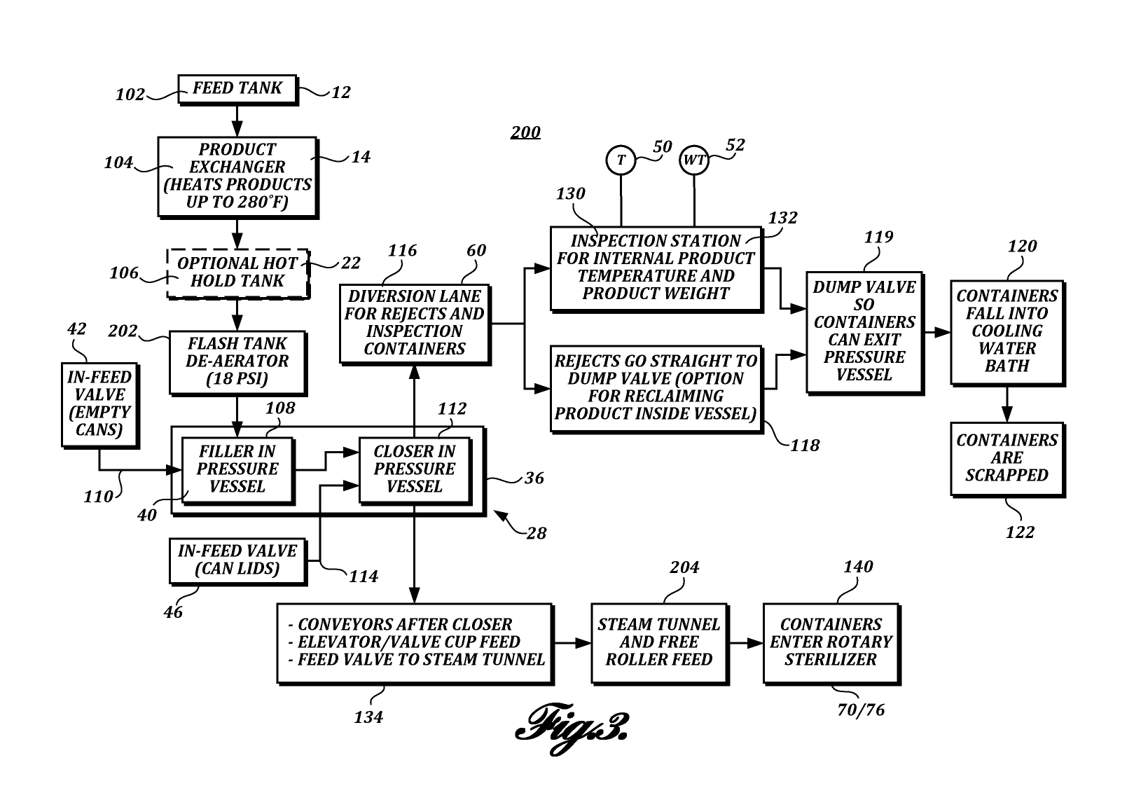

FIG. 3 illustrates a further method and system 200 according to the present disclosure, that is similar to the method and system of FIG. 2. As such, the steps and other aspects of the method shown in FIG. 3 that are the same or similar to the method of FIG. 2 are identified with the same step or part number. The following description focuses on the differences between the methods and systems shown in FIGS. 2 and 3. In this regard, a flash tank de-aerator 202 is positioned between thermal processing station 14 and pressure vessel 36. At the de-aerator, air is removed from the heated, formulated food product. Also, it is noted that at the first thermal processing station 14, the food product is heated to approximately 212° F. to 290° F. and more specifically to approximately 260° F. to 280° F., which is at the same level as in the dimpled tube heat exchanger in FIG. 2 for heating the food product.

A further differentiation between FIGS. 2 and 3 is that in FIG. 3 of the closed, filled containers, such containers are routed to a steam tunnel 204 through which the containers are delivered to the rotary sterilizer 140. This transport process helps prevent the containers and their contents from cooling to below a desired temperature.

While the preferred embodiment of the invention has been illustrated and described, it will be appreciated that various changes can be made therein without departing from the spirit and scope of the invention. For example, the temperatures to which the food product is heated in the first thermal processing station 14 can be other than about 260° F. to 280° F., for example, about 250° F. to 290° F. or about 212° F. to 290° F. Likewise, the temperature of the food product stored in the hot hold tank 22 can be other than about 240° F. to 250° F. For example, such temperature range can be from about 230° F. to 260° F. or from about 212° F. to 290° F. Further, the temperature of the fill station 28 (located within the pressure chamber 36) can be at a temperature other than about 240° F. to 250° F. For example, such temperature range could instead be from about 230° F. to 260° F. or about 212° F. to 290° F. If the electrical components of the fill station are not able to operate reliably at this temperature range, then it may be necessary to reduce the operating temperature accordingly, perhaps to the range of 120F to 140F. Of course, the temperature of the product at the fill station will then dictate the minimum pressure required of the fill station. In this regard, the minimum pressure could vary to between about 10-43 psig. In addition, the temperature of the food products and containers 30 exiting the third thermal processing station can be in a temperature range other than about 125° F. to 175° F. For instance, the thermal temperature range could instead be from about 115° F. to 185° F.

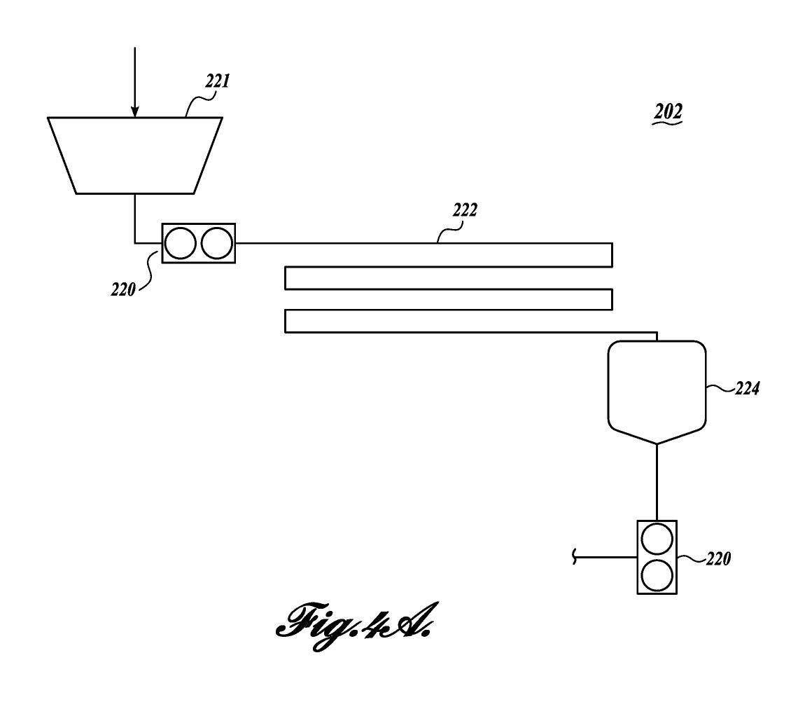

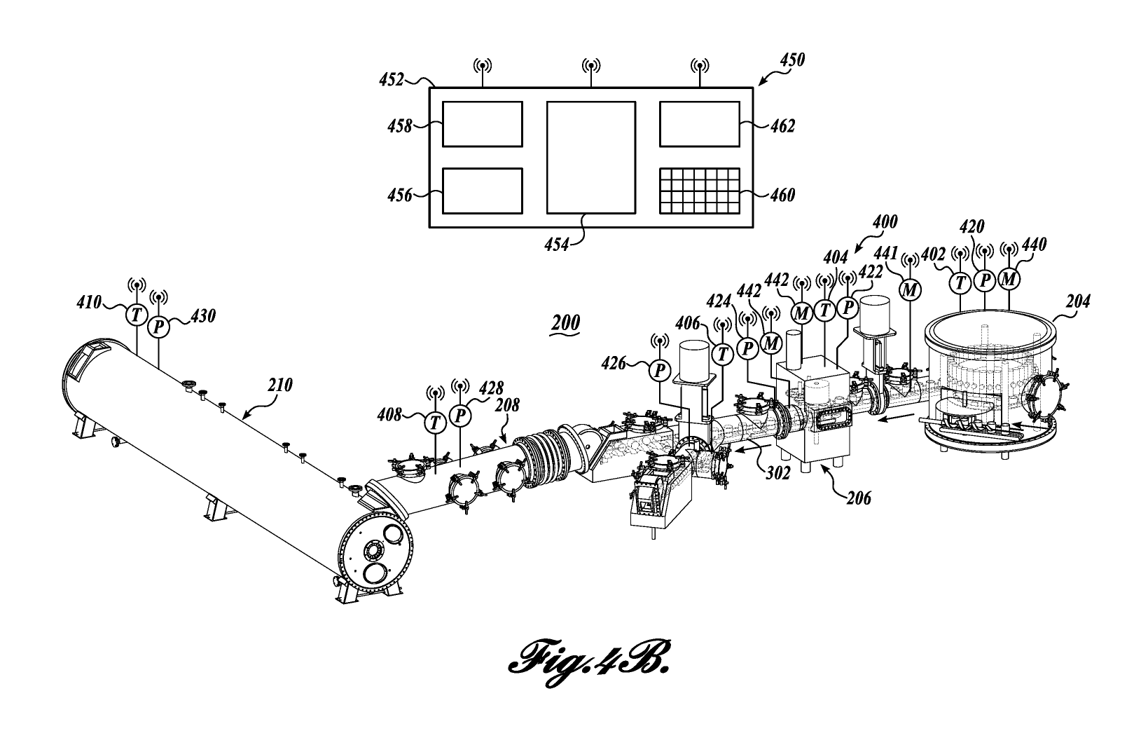

FIGS. 4A and 4B depict a further embodiment of the present disclosure pertaining to another example of an automated, unmanned continuous system 200 and method for packaging food products at elevated temperatures and pressures and also thermally processing the food products before and/or after packaging. The system 200 includes an upstream thermal processing station 202 to heat food products and direct the heated food products to a filling station 204 where containers 242 are filled with the heated food products and then transported to a sealing station 206 where the containers are sealed. If the container is in the form of a can, a lid or cover 283 is applied to the can. Thereafter, the filled and sealed containers 242 are routed through a transfer passageway or tube 208 for further processing, for example thermal processing at a downstream station 210. The system 200 is constructed so that all the foregoing steps are carried out in an unmanned, controlled elevated pressure and temperature environment thereby avoiding subjecting workers to elevated pressure and temperature working conditions found in existing container filling and sealing operations. As discussed below, system 200 is designed so that the thermal processing, filling, sealing, and other operations necessary and/or attendant to packaging of food products may be performed in compact function stations that are sealed from the ambient so as to retain the sterile conditions and desired process parameters under which the filling and sealing and thermal processing of food product containers takes place.

Next, describing system 200 in greater detail, referring initially to FIGS. 4A and 4B, a food product is initially thoroughly treated, or at least heated, at an upstream thermal processing station 202. As shown in FIG. 4A, the upstream thermal processing station 202 includes a continuous feeder 220 receiving flowable food product from a reservoir 221. The continuous feeder “pushes” the food product through a heat exchanger 222 where the food product is heated to a desired temperature level. Various types of heat exchangers may be utilized, including tubular heat exchangers wherein the exteriors of the tubes are heated by steam or other heating medium. The food product is heated within the heat exchanger to a temperature range of about 260° F. to 290° F. One target temperature within this range may be about 270° F. At this temperature, commercial sterility of the food product may be achieved. This means that the level of pathogens within the heated food product has been lowered to a level specified by food processing regulations. However, it is not necessary that commercial sterility in fact is been obtained by the time the food products leave the heat exchanger 222. Additional thermal processing of food products occurs beyond the heat exchanger 222.

The food product is then “held” for a length of time to allow the temperature of the food product to equalize and stabilize. Especially for product that has particles, the hot fluid will heat the outside of the particle and the heat will transfer to the inside of the particle via thermal conduction. The length of time for this heat to transfer to occur, depends, for example, on the size of the particles. This hold step can occur within a “hot hold tube” that is part of the heat exchanger structure or the hot hold tube can be a separate structure.

The food product may be heated in other manners in lieu of or in cooperation with the heat exchanger 222. For example, various types of heating units may be employed to rapidly heat the food product flowing from the continuous feeder 220. Such various types of heating units may include, for example, a culinary steam direct injection system, a microwave or radio frequency heating unit, or an electrically powered OHMIC heating unit.

The food product from heat station 222 is then routed to a flash tank deaerator 224. The purpose of the deaerator is to cool the food product and also to expel air that was dispersed or dissolved in the food product thereby improving the taste and the quality of the food product.

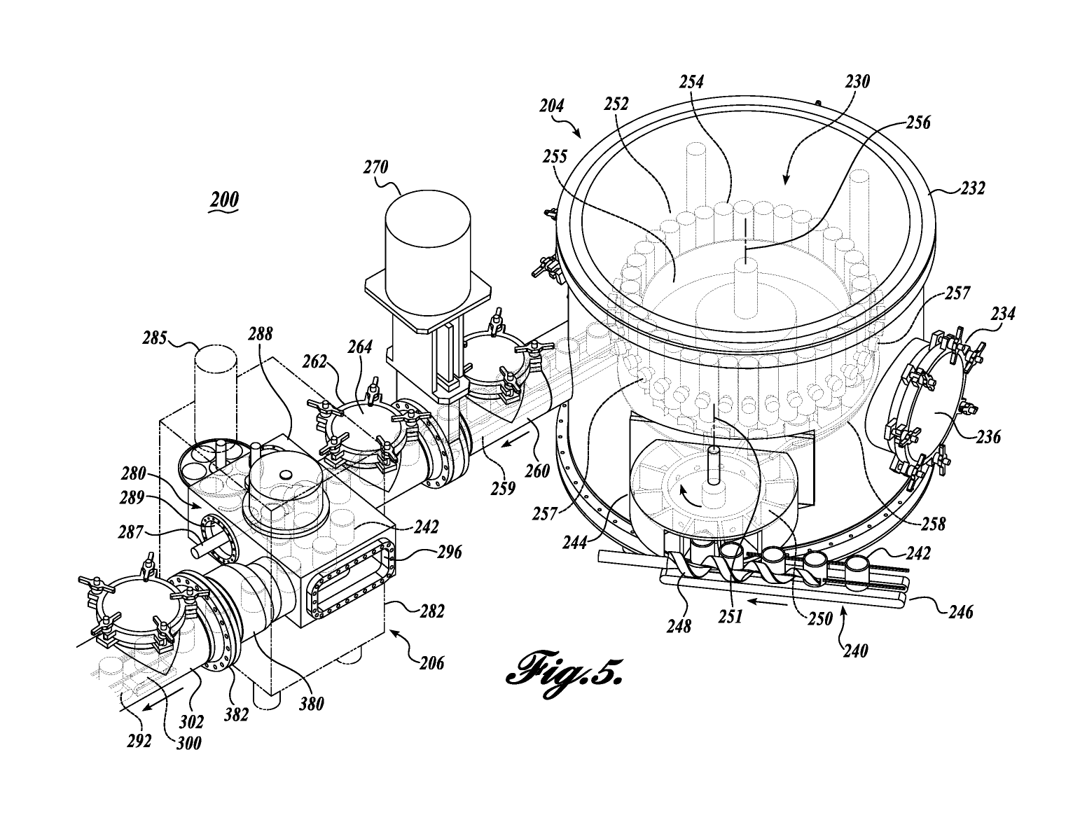

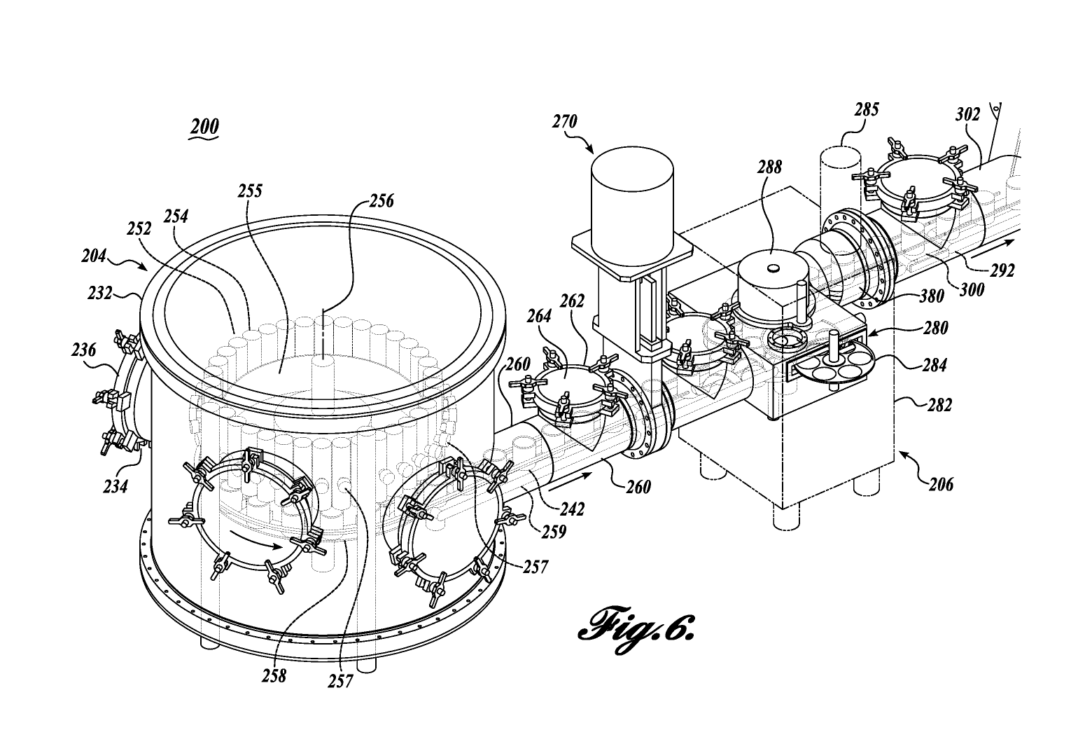

From the deaerator 224, the heated food product is routed to fill station 204. As perhaps best shown in FIGS. 5 and 6, fill station 204 includes, among other components, a filling apparatus 230 positioned within a close-fitting pressure vessel in the form of generally cylindrical housing 232 that surrounds the filling apparatus 230. The housing 232 is illustrated with its top or lid removed to provide visibility into the interior of the housing. A series of access ports 234 are disposed around the cylindrical housing. The access ports have sealed covers 236, which can be opened to provide access to the interior of the housing 232 and the filling apparatus 230 disposed therein. However, it will be appreciated that there is not enough clearance around the exterior of the filling apparatus for a work person to be positioned, rather, the idea is to encase the filling apparatus 230 in a close-fitting pressure vessel so as to reduce the necessary volume of the filling station, which makes it easier to maintain a desired pressure level and temperature level and moisture level within the pressure vessel. Also, other components of the filler station, such as motors, pumps, valves, control system electronics, etc., can be located outside of the close-fitting housing and thus not be subjected to the elevated pressure and temperature within the housing.

Still referring primarily to FIGS. 5 and 6, the filling station 204 includes a container infeed system 240 for delivering empty containers 242 to the interior of the housing 232. In this regard, the containers 242 arrive at the filling station 204 on a conveyor system 246 and then are fed into a loading turret 244 by an indexing screw 248 that presents cans 242 to circumferential cells 250 disposed around the circumference of the loading turret. The loading turret 244 is rotated about its center axis 251 so as to present the cans 242 to a filling turret 252 at the bottom of the filling apparatus 230 which occupies a majority of the volume of the housing 232. The loading turret 244 enables the containers 242 to be introduced into the housing 232 while maintaining the elevated pressure and temperature within the housing. In this regard, the loading turret 244 is sealed relative to the housing.

The filling turret 252 has a plurality of food fill tubes or valves 254 arranged in a circle about a central axis 256. The fill valves receive the food product from a filler bowl 255 located in the circular volume defined by the fill valves. The product enters the fill valve by toggling the inlet port of the fill valve, which is connected to the filler bowl, to open position by a port cam (not shown) on the top of the fill valve. When the fill valve port is open to the filler bowl the fill valve draws in product by raising piston cam 257. The fill valve port will then close (by moving the port cam) and open a drain port that will cause the product to flow down into the empty container. The piston cam moves in a downward motion to push product out of the drain port of the fill valve.

Below the fill valves 254, a rotating platform 258 receives the cans 242 from the loading turret 244 so that the containers are in registry beneath a corresponding fill tube 254 to rotatably travel with the fill tube about the central axis 256. During this travel, the food product in the fill tube 254 is transferred downwardly into the open container 242. By the time the container 242 travels to the opposite side of the housing 232 from that shown in FIG. 5 to that shown in FIG. 6, the containers 242 have been filled with food product and are released to a conveyor 259 which is tangent to the circumferential path of the rotating fill tubes 254 thereby to carry the filled containers 242 away from the filling station 204 through a transfer passage 260 leading to sealing station 206.

The filling station housing 232 is maintained under pressure so as to maintain the sterility within the housing. With the filling station housing being under pressure, the ambient environment surrounding the fill station housing is kept out of the fill station housing. Also, by pressurizing the filling station housing 232, the food product is prevented from boiling if it happens that the food product is at a temperature above 212° F. The pressure within the filling station housing is maintained at about 18 psig to about 25 psig by a sterile source of pressurized air. Also, an HVAC system is provided to maintain the moisture within the fill station housing 232 at a desired level, thereby to prevent condensation from the heated interior environment of the filling station housing to occur on surfaces of the housing 232, the interior of the containers 242 or the food product within the containers. Condensate from the ceiling could drop down into the empty or filled containers. The temperature within the sealing station housing is maintained at about 100 to 180° F. The temperature within the filling station housing might be increased, but perhaps at the expense of the performance and longevity of electronic components of the filling station.

Still referring primarily to FIGS. 5 and 6, the filled cans or containers 242 travel from the filling station housing through on the conveyor 259 through passageway 260, which is illustrated in the form of a circular pipe structure. However, the passageway 260 can be of other construction. Access ports 262 are provided along the length of the passageway 260 so as to provide access to the interior of the passageway, for example, for repairing or servicing the conveyor 259 or cleaning the interior of the passageway. Sealed covers 264 tightly close off the access ports during operation of the system 200. The passageway 260 can be in flow communication with an HVAC system to maintain the temperature, pressure and the moisture content within the passageway at a desired level.

A valve 270, illustrated in the form of a gate valve, is disposed along the passageway 260 and is operable to isolate the filling station housing 232 from the sealing station housing 282 as desired or required. For example, if access is required to the sealing station housing 282 for cleaning, repair, etc., the filling station housing can be isolated and closed off by operation of the valve 270 thereby to maintain the elevated pressure and temperature within the filling station housing as well as the desired moisture level within the filling station housing. Of course, the opposite is also true; if access to the filling station housing 232 is needed, the sealing station housing 282 can be isolated from the filling station housing to maintain its operational parameters, including the temperature, pressure, and moisture level within the sealing station housing.

Prior to the delivery of the cans 242 to the loading turret 244, the cans are washed and inspected. However, the system 200 does not require that the cans be sterilized when filled at the filling station 204. Consistent with the overall concept and design of system 200, these operations occur outside of the pressurized sections of the system 200, since an overall goal of the present application is to minimize the operations that need to occur within the pressurized and heated environment. This enables the operating parameters within the system 200 to be maintained on a more uniform basis and with less energy consumption.

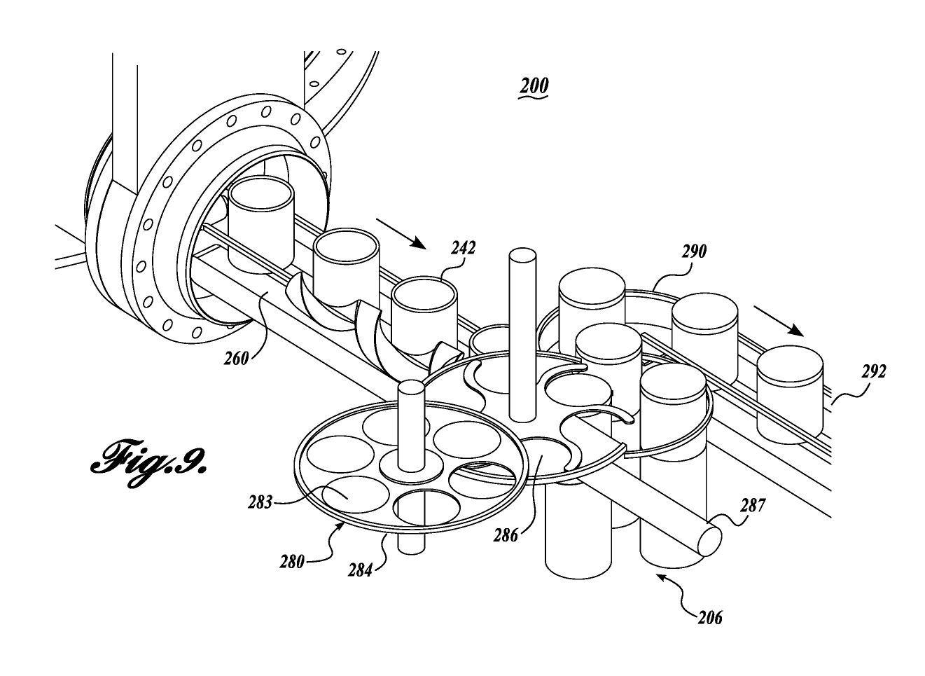

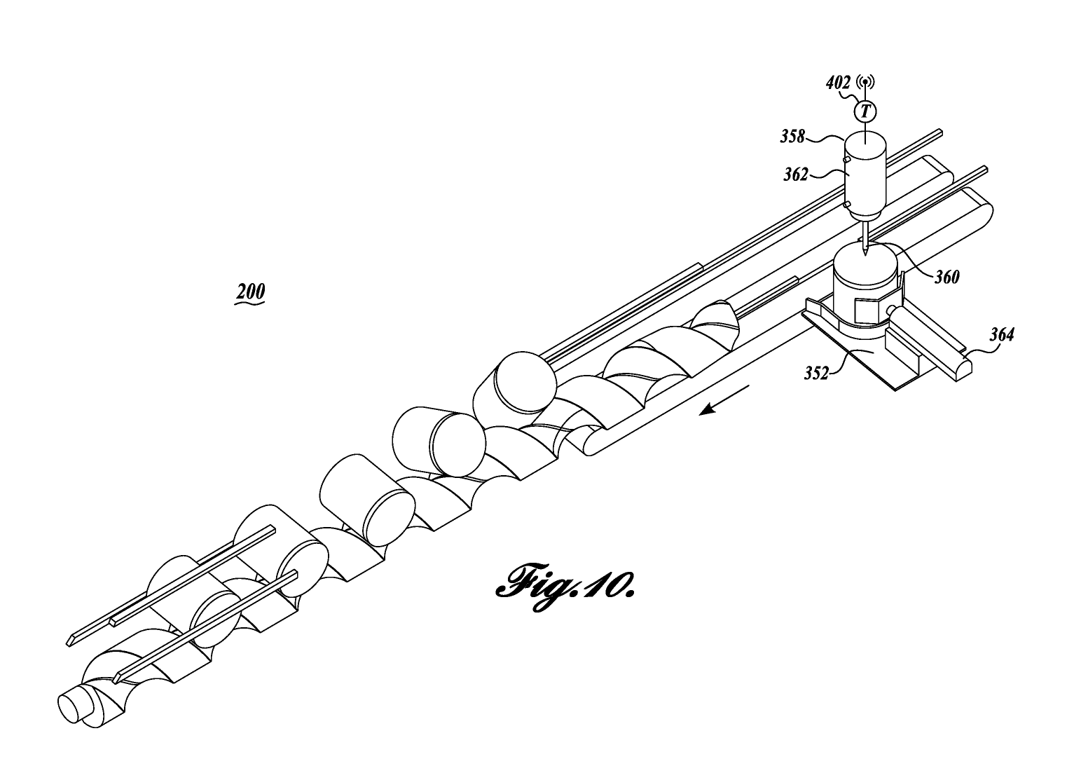

Next, referring specifically to FIGS. 5, 6 and 9, the sealing station 206 is illustrated as including a closure or sealing apparatus 280 disposed within a pressure vessel in the form of close-fitting housing 282. The closure apparatus includes a cover feed turret 284 that rotates about a central axis to place covers 283, received from an overhead cover magazine 285, onto a cover transfer mechanism 286, see FIG. 9. The magazine 285 for providing the covers 283 to the cover turret 284 extends upwardly from the housing 282 as shown in FIGS. 5 and 6. The transfer mechanism 286 places the covers 283 onto the open top of cans 242, which are transferred from conveyor 260 to a rotating lifter table, not shown, whereupon the cover is placed on the open top of the container 242. Thereafter, a seaming machine 288 folds the flanges along the circumferential perimeters of the covers and top edge portions of the containers into an air tight seam between the cover and the container in a standard manner. From the seaming machine, a discharge turret 290 transfers the sealed cans to a discharge conveyor 292 for travel along a seal transport passageway 302.

As shown in FIG. 9, the open cans 242 are fed from the conveyor 260 to the lifter table by a rotating screw 287. Also, the drive shaft for the indexing screw 287 extends outwardly from the housing 282 through a sealed opening 289 as shown in FIGURES.

It will be appreciated that by the foregoing construction, a seal is maintained between the cover turret 284 and the housing 282. This would be accomplished by using valve packing would have to be large enough to completely cover and seal the circular lid opening at the 4 o′clock and 10 o′clock as orientated in FIG. 9. This valve packing would have to cover/seal the top, bottom and OD of the valve turret 284.

Further, a seal is formed between the cover (not shown) used to cover the opening 289 and the shaft of the indexing screw 287.

An opening 296 is provided in the side of the housing 280 opposite to the cover turret 284 to permit access to the interior of the housing for servicing the closure apparatus 280, including cleaning the apparatus when necessary. A cover, not shown, is provided to nominally close off the opening 296.

As with the filling station housing 232, the passageway 302 and the sealing station housing 282 may be in flow communication with an HVAC system to maintain the passageway and sealing station housing 282 at a desired temperature and moisture level. The temperature within the passage way and housing 282 may be from about 100 to 200° F. In addition, the HVAC system can help remove moisture from the passage way 302 and filling station, including from the ceilings of the passageway and housing so condensate does not drop into the open containers 242. Also, a source of pressurized air is provided to the housing 282 to maintain the pressure within the housing and adjacent section of the passageway 302 at a desired level, for example, from 18 to 25 psig to correspond to the pressure/temperature of the food product within the filling and sealing stations .

Also, as with the filling station, components of the sealing station 206, such as motors, pumps, valves, controllers, electrical components, etc., may be located outside of the housing 282 so as not to be subjected to the elevated temperature and pressure within the housing 282.

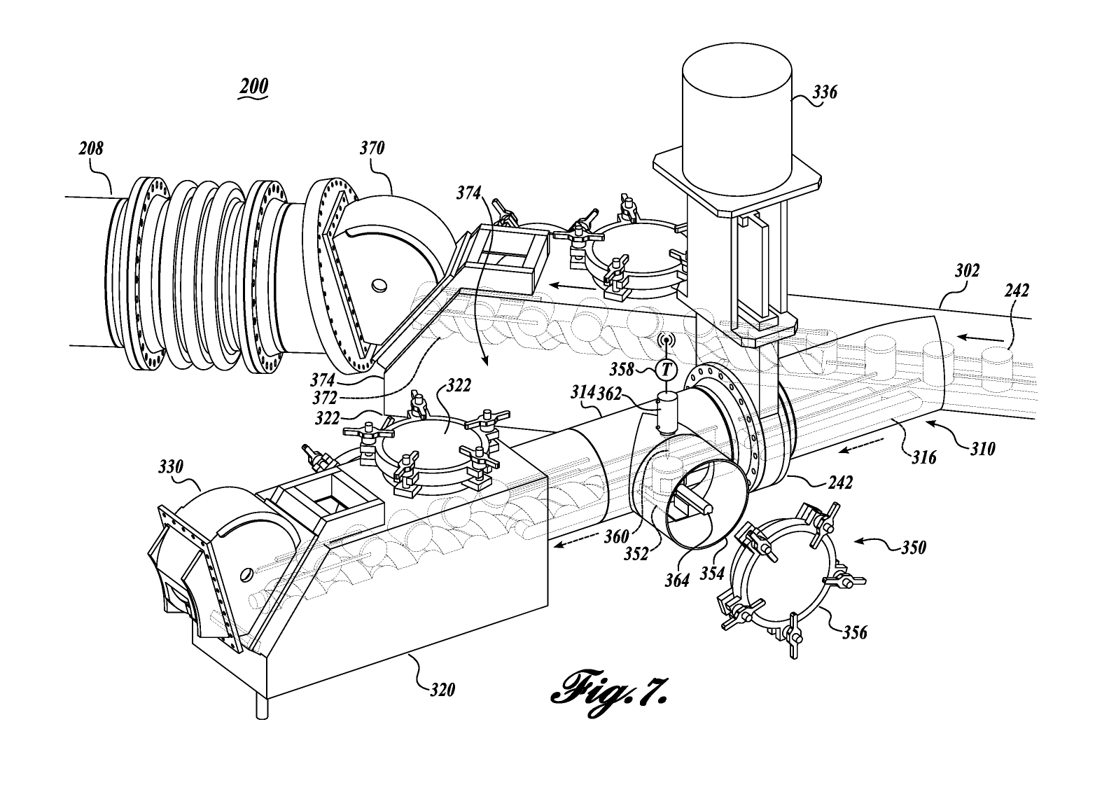

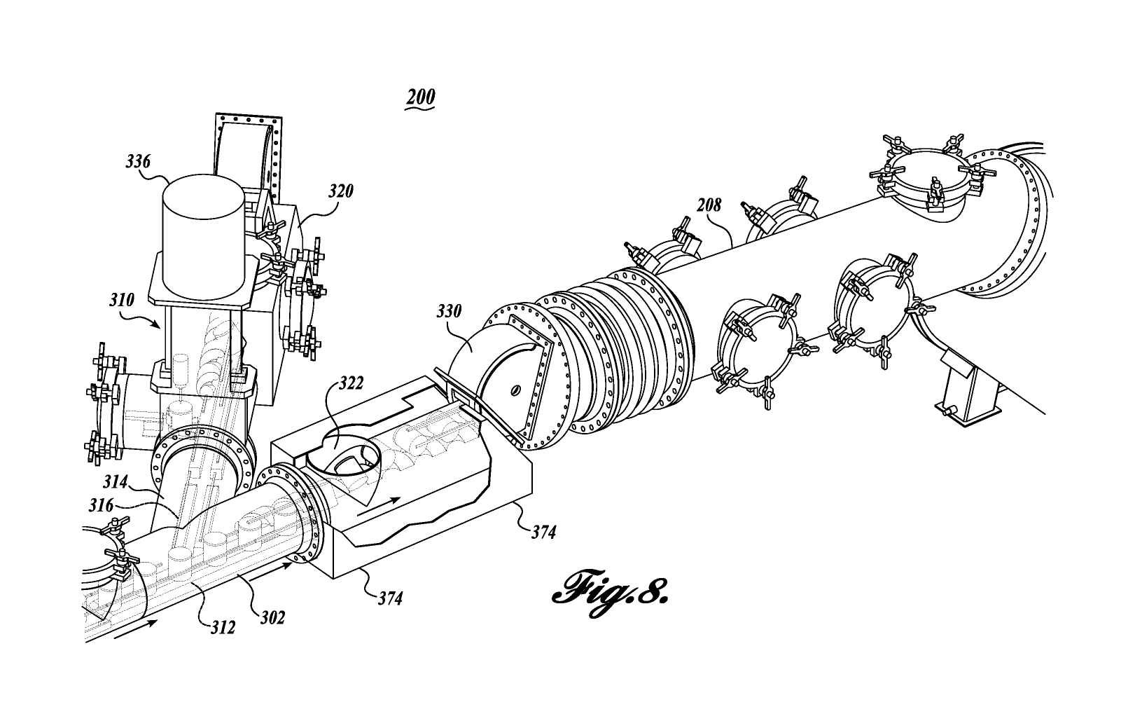

Downstream of the sealing station 206, the filled and sealed containers 242 are weighed at a weighing station 300 to make sure that the containers are an acceptable weight before continuing down the process line. The weighing station may be located within a passageway 302 leading downstream from sealing station 206. The weighing station 300 may include a weighing apparatus incorporated into the structure of the discharge conveyor 292 in a well-known manner. If the container 242 is found to be of undesirable weight, the container does not proceed through the transfer passageway 208, but rather is diverted to a diversion branch 310 by an automated diversion system 312 located at the intersection of the diversion branch 310 and passageway 302, see FIGS. 7 and 8. As illustrated in FIGS. 7 and 8, the diversion branch 310 is in the form of a tubular passageway 314 that diagonally intersects with the passageway 302. The rejected containers 242 are diverted from the discharge conveyor 292 to a diversion conveyor 316 extending along the diversion passageway 314. The diverted container 242 is carried by the conveyor 316 to an emptying station 320 where the food product is removed from the container and then the empty container is ejected from the system 200 through an airlock or rotary valve 330. As in the other components or stations of system 200, the emptying station 320 is also at an elevated pressure relative to the ambient. The pressure at the emptying station is maintained by a source of pressurized air in the manner described above with respect to maintaining the pressure at the filling station 204 and the sealing station 206. Access to the emptying station 320 may be achieved through an access opening 322 which is nominally closed by the cover 324 tightly sealed over the opening 322.

As in the passageway 260, a valve 336 is disposed within the diversion passageway 314. The valve 336 can be activated to close off the diversion branch 310 downstream from the valve from the rest of the pressurized sections of system 200, for example, when accessing the diversion branch downstream from the valve. The closed valve 336 enables the pressure, temperature and moisture level of the closed system upstream from the valve to be maintained even though the diversion branch 310 downstream from the valve is exposed to the ambient.

The system 200 also includes a quality control station 350 to monitor/validate the proper operation of system 200. The quality control station includes measuring the temperature of the contents of the filled and sealed containers 242 . This determination is made on a statistical basis wherein filled containers 242 are periodically diverted from the discharge conveyor 292 to the diversion conveyor 316 and transported by the conveyor to the quality control station 350. At the quality control station 350, the selected container is transferred to a lateral platform 352 located within a transverse stub section 354 of the diversion passageway 314. As shown in FIGS. 7 and 8, a cover 356 is provided for closing off the open end of the stub section 354.

In one aspect, the quality control station 350 measures the temperature of the food product within the containers 242. To this end, a temperature measurement apparatus 358 includes a projecting pick 360 used to pierce the cover 283 of the container 342 to reach the interior of the container and thereby measure the temperature therein using the temperature measurement device which may be incorporated into the pick 360. The pick is driven through the lid or cover 283 of the container by an actuator 362 of the apparatus 358. Once the temperature measurement is performed, the container 242 is returned to the conveyor 316 by a return mechanism 364, which may include a plunger. Thereafter, the pierced container is emptied at the emptying station 320 in the manner described above with respect to the other rejected containers including containers of undesirable weight.

The seam between the cover 283 and container 242 is inspected by two methods. In a first method, all of the cans are inspected by a load cell that is placed on the seaming heads of the closure apparatus 20. If a bad load cell reading occurs during a seaming process, the can tracking system 400 can identify the cans with a potentially bad seam.

The second time seams are inspected is for a seam “tear down.” This is done at a frequency that complies with FDA or other regulatory agency requirements, and requires one can from each of the seaming heads in the closer. The can tracking system would identify these inspection containers and send them down diversion tunnel 310. The cans will be emptied at station 320 before leaving the pressure environment through valve 330. The bottom of the cans are punctured to allow the containers to be emptied. This way, the puncturing process doesn't affect the seam that will be used in the tear down test. The tear down test is performed by an operator outside of the pressure environment of system 200.

The containers 242 that are not diverted via the diversion system 312 continue past the diversion branch 310 along passageway 302 to the transfer passageway 208 leading to downstream thermal processing station 210. An airlock or rotary valve 370 is located at the entrance to the passageway 208 thereby to maintain the desired pressure and temperature parameters within the system 200.

As shown in FIGS. 7 and 8, the filled containers 242 are rotated 90 degrees from an upright position to a horizontal position by a standard rotation screw 372 located primarily within a close-fitting housing 374 just upstream from the valve 370.

A hot water washing system is employed to wash the exterior of the sealed cans 242. The washing system is located between the sealing station 206 and the valve 370 at the entrance of the transfer passageway 208. For example, the hot water washing system may be incorporated into the housing 374, or may be at another location between the valve 370 and the sealing station 208. The washing system removes food products and other debris from the exterior of the containers so as to not introduce such debris into the thermal processing station 210. The hot water washing system can also function to maintain the desired temperature of the containers 242 and the contents therein as the containers travel along the system 200, including through the passageway 302. As such, no HVAC support is needed.

As shown in the drawings, and in particular FIGS. 1, 7, and 8, the passageway 208 is in the form of a tubular pipe section extending between the valve 370 and the thermal processing station 210. The length and shape (whether straight, curved or otherwise) may be adjusted based on the location of the processing station 210 and the type of thermal processor being employed. The figures depict a rotary retort vessel. Other types of thermal processors may be use, including hydrostatic processors and continuous belt sterilizers. It may be necessary to add heat to the interior of the transfer passageway 208 to ensure that the filled containers are kept at a minimum temperature along the transfer passageway.

As a further option, the hot can wash station 380 described above may be extended thereby to maintain the containers at a desired temperature level. In this option, the passageway 260 may be extended to replace passageway 208, in which case the rotary valve 370 would be positioned at the thermal processing station 210.

As noted above, the downstream thermal processing station 210 is depicted as a rotary sterilizer having an opening in communication with the delivery and the transfer passageway 208. The containers 242 are processed within the rotary sterilizer to achieve a desired pathogen kill level. Once this has been accomplished, the containers are cooled in a pressure cooler, not shown, to remove heat from the container and its contents. Thereafter, the containers as partially cooled in the pressure cooler are transferred to further cooler, not shown, operating at atmosphere pressure to complete the cooling process.

Certain of the containers 242 after partial cooling in the pressure cooler are diverted for inspection. In this regard, such cans have been identified by the system 200 as requiring inspection at this point in the process, and been so tracked by the system 200. Such containers bear inspection due to one or more of several reasons, including suspected low initial temperature from the temperature measurement of similarly situated containers as measured by the temperature measurement apparatus 358 described above.

Another concern may be that the cans experienced a rather long hold time after being filled but before the cans entered the rotary processing station 210. The system 200 is capable of monitoring the progress and location of each of the containers from the filling station 210 through the pressure cooler and then beyond.

A further cause of concern may be the sufficiency of the seal seam between the container 242 and its cover or lid 283. This may have been detected by the load cell reading at the scanning apparatus 280.

Even without post-cooling inspection, the system may have already decided to reject certain of the containers due to one or more of the above-noted concerns. One reason for waiting until thermal processing and then pressure cooling of the container 242 before removal from the system 200 is that it is difficult to design a system that is capable of cooling cans at the throughput rate of system 200, which may be in excess of 100 cans a minute. Moreover, the need to reject cans seldom occurs and thus providing a high capacity cooling system upstream of the thermal processing station 210 is not particularly practical or desirable.

The system 200 includes a monitoring system 400 that monitors or measures the operational parameters of system 200. Such monitoring or measuring includes monitoring the progress of each container 242 from the filling station 204 through the downstream thermal processing station 210 and beyond during the subsequent cooling of the thermally treated containers. In this regard, the monitoring system includes the weighing of each container at weighing station 300. In addition, the monitoring system may include the scanning of the seam between the container 242 and cover 283 that occurs within the system 200.

In addition, the monitoring system 400 also measures the temperature, moisture and pressure levels throughout the system 200. In this regard, the operational parameters of the system 200 are monitored by temperature sensors 402, 404, 406, 408 and 410 located at, respectively, filling station 204, sealing station 206, quality control station 350, transfer passageway 208, and thermal processing station 210. Additional temperature sensors may be positioned at other locations about the system 200. The monitoring system 400 also includes various pressure sensors positioned about the system 200 including pressure sensors 420, 422, 424, 426, 428, and 430 positioned at, respectively, filling station 204, sealing station 206, hot water washing station 380, diversion passageway 314, transfer passageway 208, and thermal processing station 210. Of course, pressure monitors may be positioned at other locations about the system 200.

The monitoring system 400 further includes moisture sensing gauges at selected locations about the system 200, including gauges 440, 441 and 442 at filling station 204, passageway 302 and at sealing station 206. Additional moisture gauges may be positioned at locations about the system 200.

The system 200 also includes a control system 450 to help ensure that system 200 operates properly and within desired process parameters, including maintaining a sufficiently high temperature level and pressure level at critical locations throughout the system 200. To this end, the various temperature, pressure and moisture measuring devices and gauges noted above may be connected to the control system 450 by hard wire, radio frequency, Bluetooth®, or other wireless transmission means. The control system 450 monitors the operational parameters of system 200 to determine that such operational parameters are within the set points that have been predetermined for these operational parameters. When the operational parameters are within the set points, it is predetermined that the system 200 is operating properly and that the containers 242 are properly filled and sealed and then thermally processed.

As shown in FIG. 4B, the control system 450 includes a processor 452 for use in controlling the system 200. The control system also includes a suitable controller 454, such as a programmable logic controller linked to the processor and having an appropriate interface 456 for connecting to various gauges, monitors and components of the system 200 to the programmable logic controller. A memory unit 458 is provided for storing information regarding system 200 and its operation, and a keyboard or other input device 460 is provided to enable the operator to communicate with the processor and programmable logic controller. Also, a display or other output device 462 is provided to convey information from the processor or control system to the operator, including the functioning of the system 200. An example of a processor-operated control system for controlling a thermal processing apparatus is disclosed by U.S. Pat. No. 6,410,066 and U.S. patent application Ser. No. 14/322854, both of which are incorporated herein by reference.

The control system, and more specifically, the computer 452 together with the controller 454, controls the various components and subsystems of system 200, including the operation of upstream thermal processing station, the filling station, the sealing station, the weighting station, the diversion system and the quality control station among others. The control system also controls the supply of pressurized air to the filling station 204, the sealing station 206, the hot water washing station 380, the diversion branch 310, the transfer passageway 208, and the downstream thermal processing station 210. The control system also monitors and controls the temperature and moisture within the filling station 204 as well as the sealing station 206. In this regard, the control system controls the operation of the HVAC system, which is connected, for example, to the filling station and the sealing station. The control system also controls the temperature at other locations along the system 200 and is capable of adding or removing heat to the system 200. Further, the control system controls the operation of valves 270 and 336 described above.

Rather than automatically adjusting the operational parameters of the system 200, the control system 450 may instead alert operators to the deviation of the affected process parameter from the preset set point. The control system can, in addition, suggest adjustments to be made to the process parameters and/or operational settings of the components of the system 200. Thereupon, the operator can make the indicated adjustments.

The control system 450 may also include a program that records the ongoing operation of system 200. Such a recording program, as well as process control programs and process deviation programs, are disclosed in U.S. Patent No. 6410066.

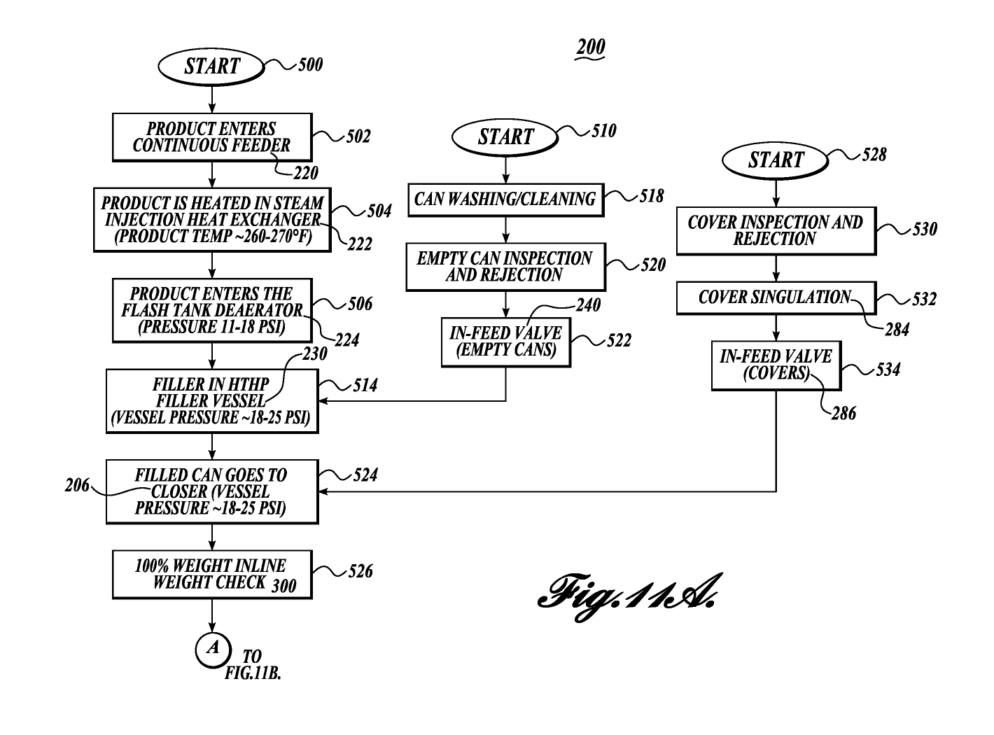

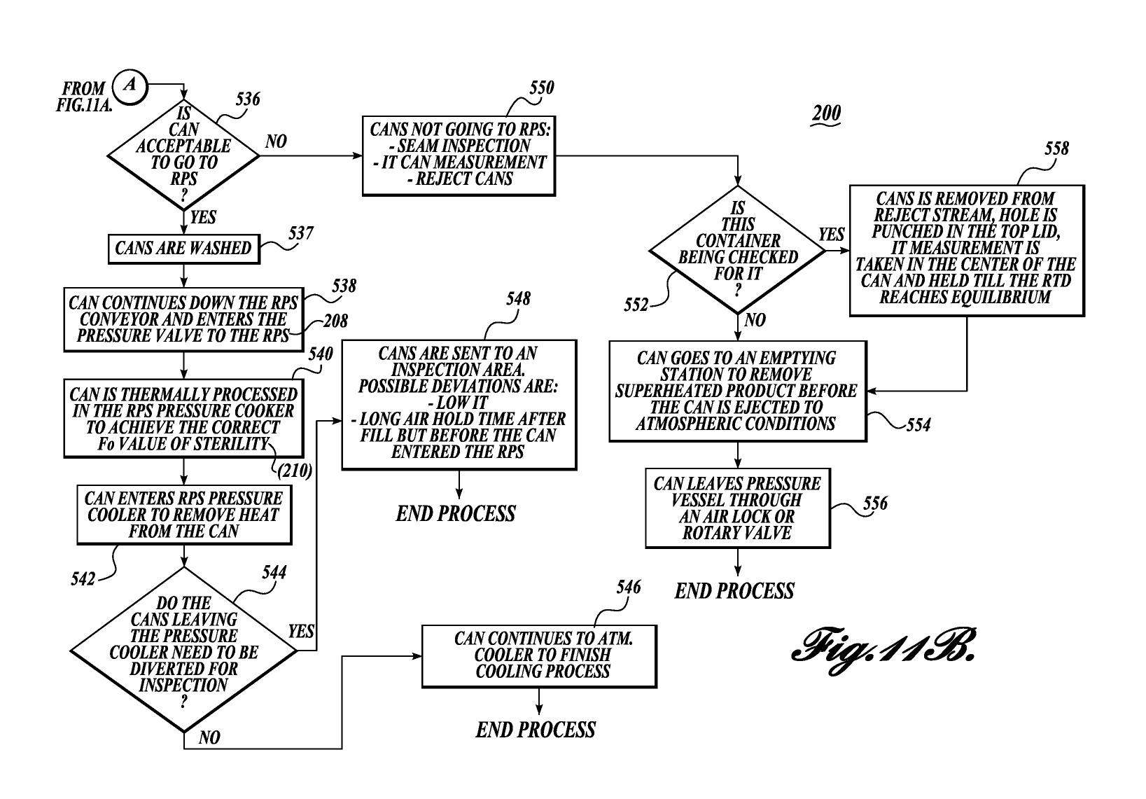

Referring to FIGS. 11A and 11B, the method of the present disclosure for automated continuous high pressure and temperature sterilization and filling of food products is illustrated schematically. In this regard, the method starts at step 500 wherein food product is delivered to a continuous feeder 220 at step 502. The continuous feeder “pushes” the food product through a heat exchanger 222 at step 504. As discussed above, after heating the food product is held in a “hot hold tube” to provide time for the temperature to equalize throughout the food product. From the heat exchanger, the food product is transferred to a deaerator (flash) tank 224 at step 506. From the deaerator (flash) tank 224, the food product is transmitted onto the filling station 204 for filling cans at step 514.

Upstream from the filling step 514 beginning at start step 516, the cans are washed or otherwise cleaned at step 518. Thereafter, the cans are inspected at step 520 and any cans that are damaged or that otherwise do not pass inspection, are rejected and removed at this step. Then, at step 522, the cans to be filled are fed by container infeed system 240 to the filling apparatus 230.

After the containers are filled at step 514, the filled containers are moved along passageway 260 to sealing station 206 where the containers are covered and sealed at step 524. Thereafter, at step 526, each of the filled cans are weighed at weighing station 300.

Prior to being used to close the containers 422, the covers 283, beginning at step 528, are inspected at step 530 and damaged or otherwise unacceptable covers are rejected. Thereafter, the covers are singulated at step 532 using singulating or cover turret 284 as illustrated in FIG. 9. Then, at step 534, the singulated covers are fed into the sealing station 206 via transfer turret 286, see again FIG. 9. The transfer turret positions the covers 283 over the containers 242 for sealing the containers.

As represented by decision step 536, if the cans are acceptable, they are transferred on to the downstream thermal processing station 210 via transfer passageway 208 at step 538. Along the way the cans are washed at step 537. Thereafter, the containers are thermally processed in the downstream thermal processing station 210 at step 540. Next, the cans are cooled first in a pressurized cooler at step 542, then cans that do not require further inspection are transferred on to a second cooling apparatus for cooling at step 546, which completes the “normal” process of filling containers with food products and then thermally processing the containers.

However, at decision step 544, some of the containers from the pressurized cooler may require inspection for possible deviations from the set point parameters that were set for the present process. This inspection occurs at step 548, and as discussed above, may be due to a low temperature reading during the quality control process. Further inspection may also be the result of a particularly long hold time after the can had been filled but before the filled can was thermally processed at downstream processing station 210. Other reasons for requiring inspection at step 548 include suspected incomplete or bad quality seam between the container and its cover or oversized food product particles that exceed FDA standards. Food products with particles are not to have particles that are larger than a certain size. This is because the FDA process for acceptable procedures for pasteurized flowable food products is set up with a “max 1 mm size” particle limit. If the particles in the flowable food product are larger than that maximum size, it is possible that the middle of such particles did not reach the correct sterilization Fo value. Larger particles equal more distance to the center (cold spot) of the particle, which equals more time required to transfer the heat to the center of the particle.

At step 548, a decision is made whether or not the inspected cans are acceptable or not. As discussed above, the monitoring system 400 monitors the progress of each of the containers 242 from the filling station 204 all the way through the end of the filling and sterilization process of the present disclosure.

Referring back to decision step 536, not all of the containers are transferred on from the sealing station to the downstream thermal processing station. Rather, at step 550, certain of the cans are diverted to a diversion branch 310 either for quality control purposes or for removal. Rejected cans for undesired weight or improper seam are removed from the process at this point. At decision step 536, if the can is rejected, it proceeds to emptying station for removal of the superheated product at step 554 before the empty can is ejected from the system through an airlock or rotary valve at step 556.

As discussed above, however, for quality control purposes the temperature of the food product within the cans is periodically measured, which occurs at step 558 using temperature measuring apparatus 358 as described above. Thereafter, the inspected cans are emptied at step 554 and then the empty cans ejected from the system at step 556.

Of course, at least certain of the above steps can be carried out in different orders than illustrated or described and in different manners than illustrated or described.

While illustrative embodiments have been illustrated and described, it will be appreciated that various changes can be made therein without departing from the spirit and scope of the invention. For example, the HVAC system may service locations in addition to those specifically described above.

Also, rather than using the cover turret 284 to deliver covers 283 to the sealing station 206, the covers could be delivered via slide valve arrangement. The slide valve can be similar to a disc tray of a CD player. The lid or cover 283 would be placed in the “disc tray” of the linear valve. The cover would then be transferred through the closers pressure boundary in a similar fashion as a CD entering a CD or DVD player. The linear valve would drop the cover 283 off inside the pressure vessel 282 and then open back up to get a new cover. Note when the linear valve is in the “open” position, the port entrance to the closer pressure vessel 282 is closed off so that the pressure in the closer vessel does not escape the vessel.

1. A closed automated continuous system for processing and packaging into containers flowable food products at elevated temperatures and pressures, the flowable food products received from an upstream food product supply source for packaging and thereafter the packaged food product is discharged for downstream processing, comprising:
(a) an unmanned filling station configured as a first pressure vessel for filling containers with thermally processed flowable food products, the filling station comprising:
(i) an automated filling apparatus for directing the flowable food product into containers;
(ii) a first pressurized housing for closely encasing the filling apparatus, the housing having access ports to provide access to the interior of the housing;
(iii) a pressurizing system for pressurizing the first housing to a pressure above the flash point of the food products; and,
(iv) a container infeed system for receiving containers into the first housing to be filled; and
(b) an unmanned sealing station in container-receiving communication with the filling station, said sealing station comprising:
(i) an intake for receiving filled containers from the filling station,
(ii) a cover infeed apparatus for receiving covers for the containers,
(iii) a closure apparatus to apply the covers to the containers to seal the containers;
(iv) a second pressurized housing closely encasing at least a portion of the closure apparatus; and
(v) a pressurizing system for pressurizing the second housing to a pressure above the flash point food product, and
(c) a sealed transport passageway extending downstream of the second housing for transporting a flow stream of filled and sealed containers for further processing.

2. The closed automated continuous system for processing and packaging food products according to claim 1, further comprising a weighing system to weigh the filled containers.

3. The closed automated continuous system for processing and packaging food products according to claim 1, further comprising an automated container diversion system diverting from the flow stream of filled containers, selected filled containers for testing for quality control purposes.

4. The closed automated continuous system for processing and packaging food products according to claim 3, further comprising a temperature measurement station associated with the diversion system for measuring the temperature of the content of the filled and sealed containers.

5. The closed automated continuous system for processing and packaging food products according to claim 1, wherein the filling station is in communication with a HVAC source for maintaining the interior of the filling station at a temperature of about 100° F. to 160° F.

6. The closed automated continuous system for processing and packaging food products according to claim 1, wherein the sealing station is in communication with a HVAC source to maintain the sealing station to a temperature at about 100° F. to 220° F.

7. The closed automated continuous system for processing and packaging food products according to claim 1, further comprising a passageway between the filling station housing and the sealing station housing, said passageway sealed from and pressurized relative to the exterior ambient.

8. The closed automated continuous system for processing and packaging food products according to claim 7, further comprising a valve located between the filling station housing and the sealing station housing, said valve selectively operable to open and close the passageway between the filling station and the sealing station.

9. The closed automated continuous system for processing and packaging food products according to claim 1, further comprising a thermal processing station located upstream from and in food product flow communication with, the filling station, said thermal processing station comprising a flow passageway to circulate the food product through a heating apparatus and a heat source to heat the food products circulating through the heating apparatus to a temperature range of about 212° F. to 290° F.

10. The closed automated continuous system for processing and packaging food products according to claim 1, wherein the sealed transport passageway extending downstream from the sealing station housing is in communication with an HVAC source for maintaining the sealed transport passageway at a desired temperature level and a desired humidity level.

11. The closed automated continuous system for processing and packaging food products according to claim 1, further comprising a washing station downstream from the sealing station for washing the filled and sealed containers, the washing station comprising:
a washing apparatus to apply washing fluid to the exterior of the filled and sealed containers; and
a third housing sealed from the ambient and closely encasing the washing apparatus.

12. The closed automated continuous system for processing and packaging food products according to claim 11, wherein the washing fluid is applied to the filled and sealed containers at a temperature and volume sufficient to maintain the exterior of the containers at a temperature range of about 245° F.-265° F., but at least slightly hotter than the fill temperature of the product.

13. The closed automated continuous system for processing and packaging food products according to claim 1, further comprising a quality control station downstream of the sealing station, said quality control station comprising a temperature measurement apparatus for measuring the temperature of the contents of the closed and sealed containers.

14. The closed automated continuous system for processing and packaging food products according to claim 13, further comprising a container diversion system for diverting selected containers from the flow stream of filled containers and directing such selected containers to the quality control station.

15. The closed automated continuous system for processing and packaging food products according to claim 1, further comprising a downstream thermal processing station for receiving filled and sealed containers from the sealed transport passageway and then thermal processing such filled and sealed containers to achieve a desired sterilization/pasteurization level of the food products with the filled and sealed containers.

16. The closed automated continuous system for processing and packaging food products according to claim 1, further comprising a control system for controlling the process parameters of the closed automated continuous system for processing and packaging food products, said process parameters comprising the temperature and pressure at one or more of the filling station, the sealing station, and the sealed transport passageway.

17. A method of automatically and continuously filling and sealing food product containers traveling in a flow stream at an elevated temperature and pressure in the flow stream, comprising:
filling containers with thermally processed flowable food products at an unmanned filling station with an automated filling apparatus for directing the flowable food products into containers, the automated filling apparatus portion of the filling station encased within a close-fitting first housing, and maintaining the pressure within the first housing at a pressure above the flash point of the food product being filled into the containers;
sealing the containers at a sealing station downstream from the filling station using a sealing apparatus at least partially encased within a close-fitting second housing capable of maintaining the pressure within the second housing at a pressure above the flash point of the food product in the containers; and
transporting the filled and sealed containers through a sealed transport passageway maintained at an elevated temperature of at least 100° F. to 220° F. from the sealing station to a downstream location for further processing.

18. The method according to claim 17, further comprising weighing the filled and sealed containers at a location downstream from the sealing station.

19. A method according to claim 17, further comprising measuring the temperature of the filled and sealed containers at a location downstream from the sealing location.

20. The method according to claim 17, further comprising providing an HVAC source to the filling station housing and the sealing station housing.

21. The method according to claim 17, further comprising washing the filled and sealed containers subsequent to sealing the containers and before further processing of the containers.

22. The method according to claim 17, further comprising diverting filled and sealed containers from the flow stream of containers for quality control review of the filled and sealed containers.

23. The method according to claim 22, wherein the further processing comprising further processing of the filled and sealed containers comprising thermal processing of the filled and sealed containers to achieve a desired sterilization/pasteurization level of the food product within the filled and sealed containers.
